(19) United States
(12) Patent Application Publication
(10) Pub. No.: US 2023/0236310 A1
(43) Pub. Date: Jul. 27, 2023

(54) Underground Exploration Radar Device

(71) Applicant: Nippon Telegraph and Telephone Corporation, Tokyo (JP)

(72) Inventors: Shoji Mochizuki, Musashino-shi, Tokyo (JP); Masayuki Tsuda, Musashino-shi, Tokyo (JP)

(21) Appl. No.: 18/007,698

(22) PCT Filed: Jun. 5, 2020
(86) PCT No.: PCT/JP2020/022361

§ 371 Date: Dec. 1, 2022

(51) Int. Cl. G01S 13/88; G01C 9/02; G01S 7/00

(52) U.S. Cl. CPC G01S 13/885; G01C 9/02; G01S 7/006; G01V 3/12

(57) ABSTRACT

There is provided with a radar unit that includes transmission/reception antennas, a holding unit that holds the transmission/reception antennas such that the transmission/reception antennas face the ground, a large spherical wheel that has an inside wall on which one end of the holding unit is fixed, three or more small spherical wheels that hold an upper half portion of the large spherical wheel such that the large spherical wheel is rollable, a movement amount sensor that detects a movement amount generated by rolling of the large spherical wheel, and a control unit that is connected to the radar unit and the movement amount sensor.

### TECHNICAL FIELD

The present invention relates to a ground penetrating radar device.

### BACKGROUND ART

A ground penetrating radar device is a device that locates positions of targets, which are lines of utilities such as electricity, water, and gas buried under the ground. The ground penetrating radar device transmits and receives electromagnetic waves in a frequency band of several hundred MHz using an antenna located proximate to the ground, and thus can measure a thickness of a soil layer, a depth to bedrock or the water table, and the like, as well as the positions of the targets.

A conventional ground penetrating radar device is disclosed in Non-Patent Literature 1, for example. Many of conventional ground penetrating radar devices are of a three-wheel cart type or a four-wheel cart type. An operator uses the cart type bodies by linearly pushing and pulling them. To grasp a structure of a three-dimensional space under the ground, it is necessary to thoroughly scan the entire area to be measured.

### CITATION LIST

### Non-Patent Literature

Non-Patent Literature 1: Ground Penetrating Radar Equipment [retrieved on May 28, 2020], the Internet <URL: http://www.geophysical.com/products/utilityscan-df>

### SUMMARY OF THE INVENTION

### Technical Problem

However, in use of the conventional ground penetrating radar devices, detection is performed by a one-dimensional scan in which the ground penetrating radar devices are linearly pushed and pulled. Thus, it is necessary to preliminarily draw measurement lines arranged in a parallel manner or in a grid pattern, to thoroughly scan the ground without repeated scanning. It may require time and efforts to draw the measurement lines on the area to be measured, and time required for the drawing may take longer than time required for measurement. Further, since a one-dimensional scan is performed, the ground penetrating radar devices may need to change in direction or can hardly turn in a narrow or small space, and this may make it difficult to perform measurement in an area to be measured where a space is narrow or small. As described above, a one-dimensional scan is performed when the conventional ground penetrating radar devices are used, and this leads to a problem regarding low usability.

The present invention has been made in view of the above problem, and it is an object of the present invention to provide a ground penetrating radar device that can perform a two-dimensional scan and has improved usability.

### Means for Solving the Problem

A ground penetrating radar device according to one embodiment of the present invention includes a radar unit that includes a transmission/reception antenna, a holding unit that holds the transmission/reception antenna such that the transmission/reception antenna faces the ground, a large spherical wheel that has an inside wall on which one end of the holding unit is fixed, three or more small spherical wheels that hold an upper half portion of the large spherical wheel such that the large spherical wheel is rollable, a movement amount sensor that detects a movement amount generated by rolling of the large spherical wheel, and a control unit that is connected to the radar unit and the movement amount sensor.

### Effect of the Invention

According to the present invention, it is possible to provide a ground penetrating radar device that can perform a two-dimensional scan and has improved usability.

### BRIEF DESCRIPTION OF DRAWINGS

FIG. 1 is a schematic view illustrating a configuration example of a ground penetrating radar device according to one embodiment of the present invention, in which FIG. 1(a) is a plan view and FIG. 1(b) is a side view.

FIG. 2 is a schematic view illustrating a specific example of a holding unit illustrated in FIG. 1.

FIG. 3 is a schematic view illustrating a configuration example of a ground penetrating radar device including a dielectric lens.

FIG. 4 is a schematic view illustrating a configuration example of a ground penetrating radar device including a power supply unit.

FIG. 5 is a schematic view illustrating a configuration example of a ground penetrating radar device including auxiliary wheels.

FIG. 6 is a schematic view illustrating a configuration example of a ground penetrating radar device including an inclination sensor, an attitude control plate, and a magnet array.

### DESCRIPTION OF EMBODIMENTS

Hereinafter, embodiments of the present invention will be described with reference to the drawings. Identical elements in multiple drawings will be denoted by the same reference signs, and their descriptions will not be repeated.

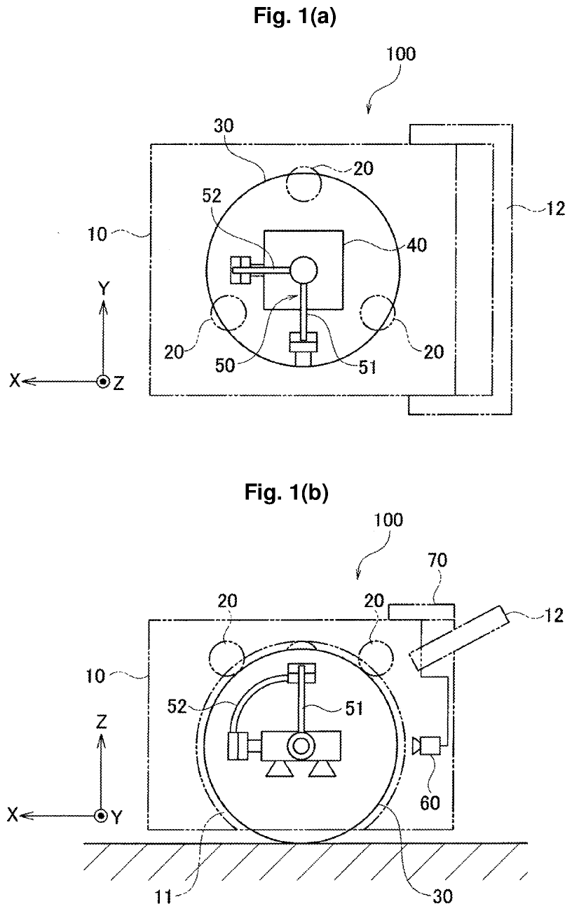

FIG. 1 is a schematic view illustrating a configuration example of a ground penetrating radar device according to one embodiment of the present invention. FIG. 1(a) is a plan view, and FIG. 1(b) is a side view. In FIG. 1(a), the left is defined as the X direction, the top is defined as the Y direction, and the front is defined as the Z direction. Accordingly, in FIG. 1(b), the left is the X direction, the top is the Z direction, and the back is the Y direction.

The ground penetrating radar device 100 illustrated in FIG. 1 is configured by, for example, a body 10 having a rectangular parallelepiped shape, and a large spherical wheel 30 housed in the body 10. Regarding the body 10, a two-dimensional scan can be performed by an operator (not illustrated) who grips a handle 12. The shape of the body 10 is not limited to a rectangular parallelepiped shape. Thus, the body 10 and the handle 12 are illustrated in virtual lines (dashed double-dotted lines).

The ground penetrating radar device 100 includes a radar unit 40, a holding unit 50, the large spherical wheel 30, small spherical wheels 20, a movement amount sensor 60, and a control unit 70.

The radar unit 40 includes transmission/reception antennas 41. The radar unit 40 emits electromagnetic waves having a frequency of several hundred MHz from the transmission/reception antennas 41 into the ground. Then, the radar unit 40 receives waves reflected from a portion under the ground in which electrical properties (dielectric permittivity) are changed, and locates positions of targets such as utility lines or the like based on a state of the reflected waves.

The radar unit 40 and the transmission/reception antennas 41 are ones commonly used. The radar unit 40 includes a stabilizer (not illustrated) such that the transmission/reception antennas 41 face downward. The stabilizer is a weight that causes the transmission/reception antennas 41 to face downward and causes the radar unit 40 to be horizontal in attitude.

The holding unit 50 performs holding such that the transmission/reception antennas 41 are maintained in their attitude so as to face the ground. Details of the holding unit 50 will be described later.

The large spherical wheel 30 has an inside wall on which one end of the holding unit 50 is fixed. The large spherical wheel 30 is a hollow ball formed of, for example, hard rubber or the like.

The small spherical wheels 20 hold an upper half portion of the large spherical wheel 30 such that the large spherical wheel 30 is rollable. The small spherical wheels 20 in this example are provided at three positions: a twelve o'clock position, an approximately four o'clock position, and an approximately eight o'clock position of a clock in FIG. 1(a). Alternatively, the number of small spherical wheels 20 may be four.

In this manner, the large spherical wheel 30 is freely rollable on the X-Y plane by operation of the operator who grips the handle 12. As a result, the ground penetrating radar device 100 can move on the ground.

The movement amount sensor 60 detects a movement amount generated by rolling of the large spherical wheel 30. The movement amount sensor 60 is, for example, a photosensor that detects, through a gap 11, the rolling of the large spherical wheel 30. A common photointerrupter may be used as the photosensor.

The control unit 70 is connected to the radar unit 40 and the movement amount sensor 60. The control unit 70 can be configured by a computer including a read only memory (ROM), a random access memory (RAM), a central processing unit (CPU), and the like. The control unit 70 includes display means (not illustrated).

The control unit 70 and the movement amount sensor 60 are connected to each other through a control line. The control unit 70 and the radar unit 40 disposed in the large spherical wheel 30, which freely rolls, are connected to each other through, for example, a weak radio communication.

The control unit 70 calculates the movement amount of the large spherical wheel 30 on the X-Y plane based on a detection signal from the movement amount sensor 60. Further, a location of a target measured by the radar unit 40 is displayed on the display means.

### Holding Unit

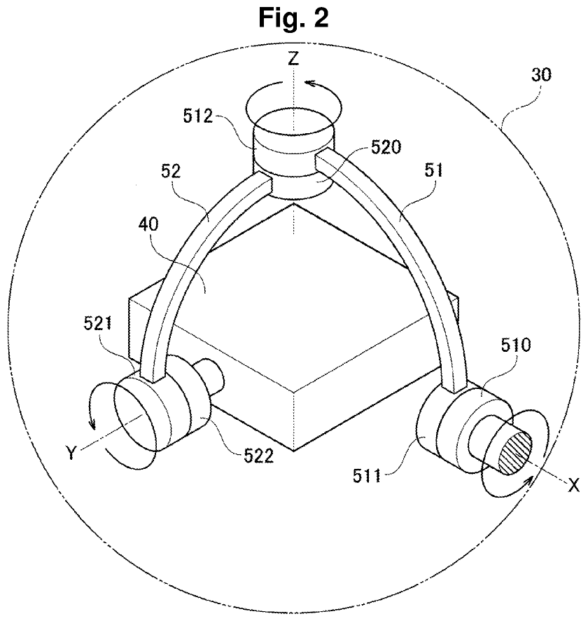

FIG. 2 is a schematic view illustrating a specific example of the holding unit 50. The X, Y, and Z axes illustrated in FIG. 2 each correspond to each direction illustrated in FIG. 1.

The holding unit 50 includes a first arm 51 and a second arm 52. The first arm 51 has a first rotation portion 511, which is one end of the first arm 51. The first rotation portion 511 is supported by a first support portion 510 provided in a location on the inside wall of the large spherical wheel 30 such that the first rotation portion 511 is rotatable 360 degrees. Thus, a second support portion 512, which is the other end of the first arm 51, is rotatable 360 degrees about the center of the first rotation portion 511 as an axis (for example, the X axis).

The first arm 51 extends, along the inside wall, to the second support portion 512 disposed at a position orthogonal to the central axis (the X axis) of the first rotation portion 511. The central axis of the second support portion 512 corresponds to the Z axis, for example.

The second support portion 512 supports a second rotation portion 520, which is one end of the second arm 52, such that the second rotation portion 520 is rotatable 360 degrees about the center of the second support portion as an axis. The second arm 52 extends, along the inside wall, from the second rotation portion 520 to a third support portion 521, which is the other end of the second arm 52. The central axis (the Y axis) of the third support portion 521 is orthogonal to the central axis (the X axis) of the first rotation portion 511, and the central axis (the Z axis) of the second support portion 512.

Thus, the radar unit 40 is supported by a third rotation portion 522, which is rotatable 360 degrees about the center of the third support portion 521 as an axis. The radar unit 40 is rotatable 360 degrees about, for example, the Y axis as the central axis thereof, and thus the radar unit 40 maintains a horizontal attitude while the transmission/reception antennas 41 (omitted in FIG. 2) face downward.

In this manner, the first arm 51 and the second arm 52 form a three-axis gimbal. The gimbal means a pivoted support that allows rotation of an object about an axis.

The first support portion 510 and the first rotation portion 511 illustrated in FIG. 2 may be located at a vertically lower position due to the rolling of the large spherical wheel 30. In this case, the first support portion 510 and the first rotation portion 511 are located immediately under the transmission/reception antennas 41. Thus, the first support portion 510, the first rotation portion 511, and the first arm 51 may be formed of a material (for example, ceramic) that allows electromagnetic waves to transmit therethrough.

As described above, the holding unit 50 of the ground penetrating radar device 100 according to the present embodiment includes the first arm 51 and the second arm 52. The first arm 51 is connected by extending, along the inside wall of the large spherical wheel 30, between the first rotation portion 511 and the second support portion 512. The first rotation portion 511 is rotatable 360 degrees about the center of the first support portion 510 fixed in a location on the inside wall, where the center of the first support portion 510 serves as the axis of the first rotation portion 511. The second support portion 512 is disposed at the position on the axis orthogonal to the first rotation portion 511. The second arm 52 is connected by extending, along the inside wall, between the second rotation portion 520 and the third support portion 521. The second rotation portion 520 is rotatable 360 degrees about the second support portion 512. The third support portion 521 is disposed at a position on the axis orthogonal to the axis of the second rotation portion 520 and the axis of the first rotation portion 511. The radar unit 40 is supported by the third rotation portion 522 that is rotatable 360 degrees about the center of the third support portion 521, where the center of the third support portion 521 serves as the axis of the third rotation portion 522. With this configuration, the radar unit 40 can maintain a horizontal attitude in which the transmission/reception antennas 41 face downward.

In the present embodiment, an example is described in which the radar unit 40 includes the stabilizer. The first rotation portion 511, the second rotation portion 520, and the third rotation portion 522 are passively rotated, due to operation of the stabilizer, in accordance with movement of the center of gravity of the radar unit 40.

Alternatively, each axis may be actively rotated. When each axis is actively rotated, each axis may be provided with an encoder, which detects a rotation angle. With this configuration, each motor, which rotates each axis, may be rotated in order to make the radar unit 40 horizontal. In this case, it is not necessary to provide the stabilizer. That is, when the motors are rotated such that values from the encoders at which the radar unit 40 becomes horizontal are obtained, it is not necessary to provide the stabilizer.

Note that when each axis is actively rotated, the motor provided in each axis may be positioned immediately under the transmission/reception antennas 41, which may affect measurement. In this case, effects caused by the first support portion 510 and first rotation portion 511 are limited to a certain degree, and thus the effects may be eliminated by signal processing. The signal processing can be easily performed by the control unit 70.

The ground penetrating radar device 100 according to the present embodiment includes the radar unit 40 that includes the transmission/reception antennas 41, the holding unit 50 that holds the transmission/reception antennas 41 such that the transmission/reception antennas 41 face the ground, the large spherical wheel 30 that has the inside wall on which the one end of the holding unit 50 is fixed, the three or more small spherical wheels 20 that hold the upper half portion of the large spherical wheel 30 such that the large spherical wheel 30 is rollable, the movement amount sensor 60 that detects the movement amount generated by the rolling of the large spherical wheel 30, and the control unit 70 that is connected to the radar unit 40 and the movement amount sensor 60. With this configuration, it is possible to provide the ground penetrating radar device that can perform a two-dimensional scan.

### Dielectric Lens

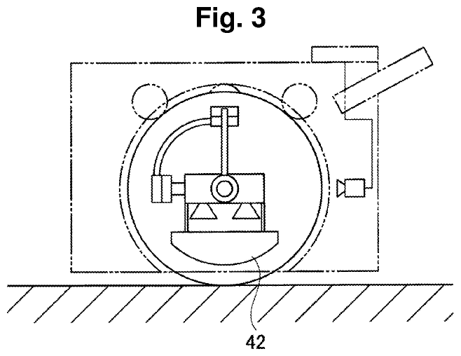

FIG. 3 is a schematic view illustrating a configuration example of the ground penetrating radar device including a dielectric lens. The dielectric lens 42 illustrated in FIG. 3 is disposed under the transmission/reception antennas 41.

As illustrated in FIG. 3, the dielectric lens 42 is supported by the radar unit 40, and is disposed on a lower side of the transmission/reception antennas 41. The dielectric lens 42 is formed of, for example, a fluororesin or a ceramic material, and operates such that electromagnetic waves emitted from the transmission/reception antennas 41 to the ground become parallel or are focused. With this configuration, it is possible to improve detection sensibility for a target under the ground.

Further, the dielectric lens 42 operates as a stabilizer, and thus it is possible to achieve an effect of stabilizing the attitude of the radar unit 40.

### Power Supply Unit

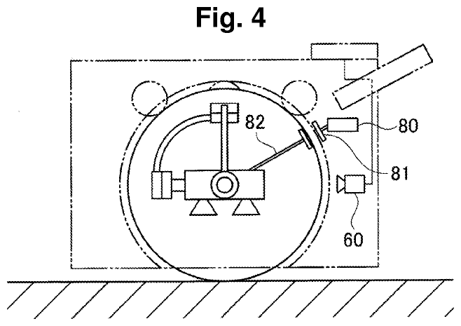

FIG. 4 is a schematic view illustrating a configuration example of the ground penetrating radar device including a power supply unit. The power supply unit 80 illustrated in FIG. 4 is provided in the body 10.

Although it is not particularly described, an example is described in which the radar unit 40 includes a power supply that supplies power required for operation of the radar unit 40, in the above embodiments. However, the power may be supplied from the outside of the large spherical wheel 30.

The power supply unit 80 supplies power to the radar unit 40. That is, the power is supplied from the outside of the freely rolling large spherical wheel 30 to the radar unit 40 provided inside the large spherical wheel 30. The power supply unit 80 supplies a current controlled by the control unit 70 to a power supply antenna 81, and then the current is converted into a magnetic flux.

The magnetic flux created in the power supply antenna 81 is electromagnetically coupled to a power reception antenna 82 that is connected to the radar unit 40, and then the magnetic flux is converted into power required for the operation of the radar unit 40. The attitude of the radar unit 40 is constantly maintained to be horizontal due to operation of the holding unit 50, and thus a position and an attitude of the power reception antenna 82 are also constantly maintained to a certain position and a certain attitude. Therefore, the power can be constantly supplied even when a position of the power supply antenna 81 provided on a side of the body 10 is fixed.

As described above, the body 10 that houses the large spherical wheel 30 includes the power supply unit 80 that supplies power to the radar unit 40, and the radar unit 40 includes the power reception antenna 82 that receives power from the power supply unit 80. With this configuration, it is possible to supply power from the outside of the large spherical wheel 30 to the radar unit 40, and thus the radar unit 40 can be configured without a battery. As a result, it is possible to make the radar unit 40 smaller and lighter, and thus movement controllability of the holding unit 50 can be enhanced. That is, this allows the attitude of the radar unit 40 to be stabilized, and therefore, detection accuracy for a target under the ground can be improved.

### Auxiliary Wheels

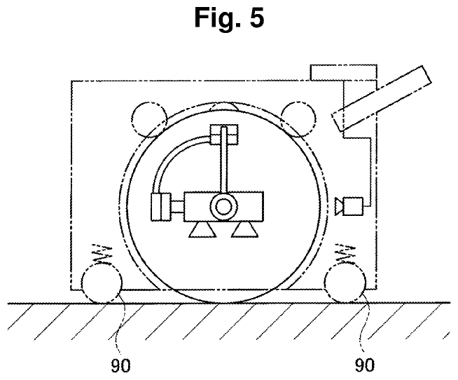

FIG. 5 is a schematic view illustrating a configuration example of the ground penetrating radar device including spherical auxiliary wheels. As illustrated in FIG. 5, the auxiliary wheels 90 are disposed at, for example, lower four corners of the body 10.

With the auxiliary wheels 90, a bottom surface of the body 10 can be maintained in parallel with the ground. Vibration proof dampers for reducing vibration may be provided between the auxiliary wheels 90 and the body 10. The provision of the vibration proof dampers allows the attitude of the body 10 to be further stabilized.

Note that it is not necessary to dispose four auxiliary wheels 90. For example, two auxiliary wheels may be disposed in the bottom of the body 10 on a side of the handle 12, and thus the body 10 may be supported at three points by the large spherical wheel 30 and the two auxiliary wheels.

As described above, the two or more spherical auxiliary wheels 90 are disposed on the bottom of the body 10 that houses the large spherical wheel 30. With this configuration, it is possible to stabilize the attitude of the ground penetrating radar device 100 with respect to the ground.

### Attitude Control of Radar Unit

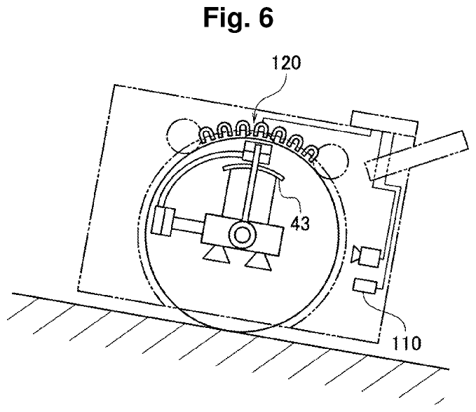

FIG. 6 is a schematic view illustrating a configuration example of the ground penetrating radar device including an inclination sensor, an attitude control plate, and a magnet array. With the configuration of the inclination sensor 110, the attitude control plate 43, and the magnet array 120, illustrated in FIG. 6, the attitude of the radar unit 40 is controlled.

The inclination sensor 110 detects inclination of the body 10. The inclination sensor 110 may operate based on any detection principles. For example, a common inclination sensor may be used in which capacitance is changed by the gravitational force. Information on the inclination of the body 10 detected by the inclination sensor 110 is input to the control unit 70.

The attitude control plate 43 is a magnetized body, and is disposed near the inside wall of the large spherical wheel 30 without interfering with the holding unit 50 and is provided on a side of the radar unit 40 opposite to a side of the transmission/reception antennas 41. The attitude control plate 43 is formed of, for example, iron (Fe).

The magnet array 120 includes electromagnets, which are aligned in, for example, seven rows and seven columns and are disposed so as to be spaced from the large spherical wheel 30 through the gap 11. The multiple electromagnets forming the magnet array 120 are each selectively magnetized by a control signal transmitted from the control unit 70. Magnetic forces of the electromagnets are controlled including their polarities.

When the magnet array 120 is not magnetized, the radar unit 40 maintains a horizontal attitude orthogonal to the vertical direction, through the operation of the holding unit 50. That is, electromagnetic waves cannot be emitted vertically with respect to the inclined ground.

Thus, the magnet array 120 is selectively magnetized based on the information on the inclination from the inclination sensor 110, which allows the radar unit 40 to be horizontal with respect to the ground, as illustrated in FIG. 6. FIG. 6 illustrates an example in which electromagnets located at positions higher than positions of the other electromagnets are magnetized and thus the radar unit 40 is rotated clockwise.

As described above, the ground penetrating radar device 100 may include the inclination sensor 110, the attitude control plate 43, and the magnet array 120. In this case, the inclination sensor 110 detects the inclination of the body 10 that houses the large spherical wheel 30. The attitude control plate 43 is a magnetized body. The attitude control plate 43 is disposed at the nearest position to the inside wall of the large spherical wheel 30, where the nearest position is a nearest position at which the attitude control plate 43 does not interfere with the holding unit 50, and is provided on the side of the radar unit 40 opposite to the side of the transmission/reception antennas 41. The magnet array 120 is disposed so as to be spaced from the large spherical wheel 30 through the gap 11. Further, the control unit 70 may be configured to selectively magnetize some of the magnets of the magnet array 120 in accordance with the inclination of the body 10. With this configuration, electromagnetic waves emitted by the radar unit 40 can be vertical with respect to the ground.

The attitude control plate 43 may be magnetized. Further, magnets having the same polarity may be attached to the attitude control plate 43. That is, repulsive force of the magnetic force may be utilized. In the case as illustrated in FIG. 6, when an assumption is made that the attitude control plate 43 is configured by, for example, S-pole magnets, electromagnets at higher positions are magnetized to the N-pole and electromagnets at lower positions are magnetized to the S-pole. In this manner, the repulsive forces of the magnets may be utilized.

As described above, the ground penetrating radar device 100 according to the present embodiments can perform a two-dimensional scan on the X-Y plane. Thus, the ground penetrating radar device 100 can be moved over an area to be measured so as to thoroughly cover this area. As a result, even when the area to be measured is narrow or small, measurement is easily achieved. Further, it is possible to make underground detection more efficient because it is not necessary to preliminarily draw measurement lines arranged in a parallel manner or in a grid pattern on the area to be measured.

In addition, increasing a diameter of the large spherical wheel 30 can improve mobility performance of the ground penetrating radar device 100. Further, only the large spherical wheel 30 is in contact with the ground, and thus the operation can be performed by only a small force, which enables easy operation.

Note that an example has been described in which the movement amount of the large spherical wheel 30 is detected by the photosensor, but the present invention is not limited to this example. The rolling of the large spherical wheel 30 in the three axial directions may be detected by three rollers. In addition, an example has been described in which the body 10 has a rectangular parallelepiped shape, but the body 10 may have any shape. Further, the ground penetrating radar device 100 may include each of the dielectric lens 42, the power supply unit 80, the auxiliary wheels 90, and the configuration for the attitude control of the radar unit 40, which have been described above, individually, or may include a combination thereof.

As described above, the present invention is not limited to the above embodiments, and can be modified without departing from the spirit of the present invention. It goes without saying that the present invention includes various embodiments and the like that have not been described herein. Therefore, the technical scope of the present invention shall be determined only by the matters to specify the invention according to the appended claims that are regarded appropriate from the above descriptions.

### Reference Signs List

10 Body
20 Small spherical wheel
30 Large spherical wheel
40 Radar unit
50 Holding unit
60 Movement amount sensor
70 Control unit
80 Power supply unit
81 Power supply antenna
82 Power reception antenna
90 Spherical auxiliary wheel
100 Ground penetrating radar device
110 Inclination sensor
120 Magnet array
510 First support portion
511 First rotation portion
512 Second support portion
520 Second rotation portion
521 Third support portion
522 Third rotation portion

1. A ground penetrating radar device comprising:
a radar unit that includes a transmission/reception antenna;
a holding unit that holds the transmission/reception antenna such that the transmission/reception antenna faces a ground;
a large spherical wheel that has an inside wall on which one end of the holding unit is fixed;
three or more small spherical wheels that hold an upper half portion of the large spherical wheel such that the large spherical wheel is rollable;
a movement amount sensor that is configured to detect a movement amount generated by rolling of the large spherical wheel; and
a control unit that is connected to the radar unit and the movement amount sensor.

2. The ground penetrating radar device according to claim 1, wherein
the holding unit includes:
a first arm that is connected by extending, along the inside wall of the large spherical wheel, between a first rotation portion and a second support portion, the first rotation portion being rotatable 360 degrees about a center of a first support portion fixed in a location on the inside wall, the center of the first support portion serving as an axis of the first rotation portion, the second support portion being disposed at a position on an axis orthogonal to the first rotation portion; and
a second arm that is connected by extending, along the inside wall, between a second rotation portion and a third support portion, the second rotation portion being rotatable 360 degrees about the second support portion, the third support portion being disposed at a position on an axis orthogonal to an axis of the second rotation portion and the axis of the first rotation portion, and
the radar unit is supported by a third rotation portion that is rotatable 360 degrees about a center of the third support portion, the center of the third support portion serving as an axis of the third rotation portion.

3. The ground penetrating radar device according to claim 1, comprising a dielectric lens that is disposed under the transmission/reception antenna.

4. The ground penetrating radar device according to claim 1, wherein a body that houses the large spherical wheel includes a power supply unit that is configured to supply power to the radar unit, and
the radar unit includes a power reception antenna that is configured to receive power from the power supply unit.

5. The ground penetrating radar device according to claim 1, comprising two or more spherical auxiliary wheels that are disposed on a bottom of the body that houses the large spherical wheel.

6. The ground penetrating radar device according to claim 1, comprising:
an inclination sensor that is configured to detect inclination of the body that houses the large spherical wheel;
an attitude control plate that is a magnetized body, the attitude control plate being disposed at a nearest position to the inside wall and provided on a side of the radar unit opposite to a side of the transmission/reception antenna, the nearest position being a nearest position at which the attitude control plate does not interfere with the holding unit; and
a magnet array that is disposed so as to be spaced from the large spherical wheel through a gap, wherein
the control unit is configured to selectively magnetize some of magnets of the magnet array in accordance with the inclination.

7. The ground penetrating radar device according to claim 2, comprising a dielectric lens that is disposed under the transmission/reception antenna.

8. The ground penetrating radar device according to claim 2, wherein a body that houses the large spherical wheel includes a power supply unit that is configured to supply power to the radar unit, and
the radar unit includes a power reception antenna that is configured to receive power from the power supply unit.

9. The ground penetrating radar device according to claim 3, wherein a body that houses the large spherical wheel includes a power supply unit that is configured to supply power to the radar unit, and
the radar unit includes a power reception antenna that is configured to receive power from the power supply unit.

10. The ground penetrating radar device according to claim 2, comprising two or more spherical auxiliary wheels that are disposed on a bottom of the body that houses the large spherical wheel.

11. The ground penetrating radar device according to claim 3, comprising two or more spherical auxiliary wheels that are disposed on a bottom of the body that houses the large spherical wheel.

12. The ground penetrating radar device according to claim 4, comprising two or more spherical auxiliary wheels that are disposed on a bottom of the body that houses the large spherical wheel.

13. The ground penetrating radar device according to claim 2, comprising:
an inclination sensor that is configured to detect inclination of the body that houses the large spherical wheel;
an attitude control plate that is a magnetized body, the attitude control plate being disposed at a nearest position to the inside wall and provided on a side of the radar unit opposite to a side of the transmission/reception antenna, the nearest position being a nearest position at which the attitude control plate does not interfere with the holding unit; and
a magnet array that is disposed so as to be spaced from the large spherical wheel through a gap, wherein
the control unit is configured to selectively magnetize some of magnets of the magnet array in accordance with the inclination.

14. The ground penetrating radar device according to any claim 3, comprising:
an inclination sensor that is configured to detect inclination of the body that houses the large spherical wheel;
an attitude control plate that is a magnetized body, the attitude control plate being disposed at a nearest position to the inside wall and provided on a side of the radar unit opposite to a side of the transmission/reception antenna, the nearest position being a nearest position at which the attitude control plate does not interfere with the holding unit; and
a magnet array that is disposed so as to be spaced from the large spherical wheel through a gap, wherein
the control unit is configured to selectively magnetize some of magnets of the magnet array in accordance with the inclination.

15. The ground penetrating radar device according to claim 4, comprising:
an inclination sensor that is configured to detect inclination of the body that houses the large spherical wheel;
an attitude control plate that is a magnetized body, the attitude control plate being disposed at a nearest position to the inside wall and provided on a side of the radar unit opposite to a side of the transmission/reception antenna, the nearest position being a nearest position at which the attitude control plate does not interfere with the holding unit; and
a magnet array that is disposed so as to be spaced from the large spherical wheel through a gap, wherein
the control unit is configured to selectively magnetize some of magnets of the magnet array in accordance with the inclination.

16. The ground penetrating radar device according to claim 5, comprising:
an inclination sensor that is configured to detect inclination of the body that houses the large spherical wheel;
an attitude control plate that is a magnetized body, the attitude control plate being disposed at a nearest position to the inside wall and provided on a side of the radar unit opposite to a side of the transmission/reception antenna, the nearest position being a nearest position at which the attitude control plate does not interfere with the holding unit; and
a magnet array that is disposed so as to be spaced from the large spherical wheel through a gap, wherein
the control unit is configured to selectively magnetize some of magnets of the magnet array in accordance with the inclination.
